(19) United States
(12) Patent Application Publication
(10) Pub. No.: US 2014/0164036 A1
(43) Pub. Date: Jun. 12, 2014

(54) Program Sentiment Analysis, Systems and Methods

(71) Applicant: FLUOR TECHNOLOGIES CORPORATION, Aliso Viejo, CA (US)

(72) Inventor: Robert Prieto, Princeton Junction, NJ (US)

(73) Assignee: FLUOR TECHNOLOGIES CORPORATION, Aliso Viejo, CA (US)

(21) Appl. No.: 14/044,742

(22) Filed: Oct. 2, 2013

Related U.S. Application Data
(63) Continuation-in-part of application No. 13/709,996, filed on Dec. 10, 2012.

(51) Int. Cl. G06Q 10/06; G06F 17/27

(52) U.S. Cl. CPC G06Q 10/063; G06F 17/2785
USPC 705/7.11

(57) ABSTRACT

Sentiment-based program management systems and methods are presented. A sentiment analysis engine obtains a set of terms (e.g., words, phrases, etc.) from a semantic terminology database where the terms are associated with a target capital program (e.g., large scale construction, etc.). The engine uses a semantic model related to the target program to analyze a set of program status documents term-by-term, especially analyzing documents related to a performance metric (e.g., milestones, etc.). Each term in the document found in the set of terms can be assigned a connotation or other sentiment value according to the model, possibly based on a context. The engine compiles a complete program sentiment from documents and presents the program sentiment with respect to one or more related performance metrics.

This application is a continuation-in-part of and claims priority to U.S. patent application Ser. No. 13/709,996 filed on Dec. 10, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is program management technologies.

### BACKGROUND

The following description includes information that may be useful in understanding the present invention. It is not an admission that any of the information provided herein is prior art or relevant to the presently claimed invention, or that any publication specifically or implicitly referenced is prior art.

Large scale construction programs (e.g., nuclear power plants, bridges, etc.) can span extended periods of time that could encompass decades or even a century. Due to the sheer scale of such programs, program personnel can understandably suffer from perceptional drift with respect to the program's strategic business objectives (SBOs). Further, in view that changes in perception of a SBO might change slowly with time, it is possible that a change might not necessarily be observable on a more human-perceivable time scales (e.g., day, weeks, months, etc.). For long lasting programs, program management personnel would likely benefit from some form of leading indicator that perception of an SBO might shift. The Applicant has appreciated that perceptional information with respect to an SBO, performance metrics for example, could include sentiment information that could operate as a leading indicator of performance issues associated with a target program.

Interestingly, sentiment information has been used in a wide range of fields for various purposes. For example, U.S. patent application publication 2013/0054486 to Eder titled “Extended Management Systems”, filed Jun. 14, 2012, discusses analyzing five segments of value for an enterprise in an organization, where the value could include market sentiment. Eder contemplates using the market sentiment as an indicator of value. However, Eder's approach fails to provide insight into leveraging sentiment information with respect to performance metrics that could give rise to desirable leading indicators.

Another example includes international patent application publication WO 2013/030830 to Levy et al. titled “Automatic Ranking of Entities Based on Interactions Therebetween”, filed Aug. 19, 2012, describes using sentiment analysis to determine whether interactions between entities is positive, negative, or in a range between positive and negative. The sentiment of an interaction can be determined based on analyzing communications between individuals. Although useful with respect to person-to-person interactions, Levy also fails to provide direction toward leveraging sentiment information with respect to program performance.

Still another example of a sentiment analysis is described in U.S. patent application publication 2013/0024465 Schiff et al. titled “Method and Apparatus for Quickly Evaluating Entities”, filed Jul. 19, 2012. Schiff describes optionally performing sentiment analysis on messages to understand whether an experience (e.g., dinner at a restaurant) was positive or negative and to what degree. Schiff is similar to Levy and Eder in the sense that Schiff provides some insight into conducting sentiment analysis, but fails to address how to leverage sentiment information with respect to performance metrics.

Further progress is made by U.S. patent application 2013/0197967 to Pinto et al. titled “Collaborative Systems, Devices, and Processes for Performing Organizational Projects, Pilots Projects, and Analyzing New Technology Adoption”, filed Feb. 1, 2013. Pinto describes using agent feedback to determine an agent's sentiment toward various aspects of a project. Interestingly, Pinto indicates that a report could be contain a sentiment analysis, but fails to appreciate that sentiment information could be extracted from program status documents to generate a sentiment with respect to one or more performance metrics of the program.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for systems or methods that could give rise to leading indicators of program performance issues based on sentiment information.

### SUMMARY OF THE INVENTION

The inventive subject matter provides apparatus, systems and methods in which a program manager can monitor or track sentiment data related to a capital program; a large scale construction for example. One aspect of the inventive subject matter includes a capital program management system having a semantic terminology database and a sentiment analysis engine. The semantic terminology database is configured to store one or more terms (e.g., digital text, digital audio words, digital images, tokens, etc.) where the terms are correlated with program attributes. Further, the terms can represent perceptional information associated with a program. For example, a term can relate to how one or more program personnel perceive an aspect of the program. The sentiment analysis engine is configured to obtain one or more sets of terms related to a program, possibly through submission of a query to the semantic terminology database. The query can be constructed based on program attributes that describe the target program. The sentiment analysis engine is further configured to obtain a semantic model related to the target program where the semantic model provides information about how the terms could be analyzed and assigned sentiment values with respect to the target program. Thus, one set of terms might be processed differently based on different semantic models. The sentiment analysis engine further obtains a set of program status document associated with one or more program performance metrics (e.g., milestones, personnel performance, trends, rates, logistics, etc.). Example program status documents could include emails (e.g., informal documents), structured reports, narrative reports, or other types of structured, unstructured or semi-structured digital documents. The sentiment analysis engine processes the program status documents by identifying terms in the documents that are also in the set of terms. Each term in the documents can then be analyzed and assigned values according to the semantic model. The engine derives a program sentiment associated with the performance metric based on the analyzed terms where the program sentiment can be presented via an output device.

Another aspect of the inventive subject matter includes a method of generating a program sentiment via a sentiment analysis engine. Contemplated methods include providing access to a semantic terminology database (e.g., third party database, private database, trade secret database, etc.) where the semantic terminology database stores terms correlated with program attributes and perceptional information. The methods can further include obtaining one or more sets of terms from the semantic terminology database based on program attributes associated with a target program, possibly through a query submitted to the database. The sentiment analysis engine can further obtain a semantic model that is bound to or otherwise related to the target program. In some embodiments, the semantic model can be obtained from a semantic model database. Further, the sentiment analysis engine can also obtain one or more program status documents that describe a status of the program with respect to one or more performance metrics. The disclosed methods also include the sentiment analysis engine deriving a program sentiment associated with the performance metric based on analyzing and assigning values to terms within the program status documents according to the semantic model and based on the set of terms. An additional step of the methods could include configuring an output device (e.g., printer, analysis engine, browser interface, etc.) to present the program sentiment, possible to a program manager. Such presentations might include dynamic type displays which prioritize the sentiment information to be presented based on program sentiment expressed and the associated semantic model.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a program management system capable of providing performance metric sentiment data.

FIG. 2 is a schematic illustrating generation of a program sentiment.

FIG. 3 is a schematic of a method of generating a program sentiment via a sentiment analysis engine.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are also used euphemistically to mean that two or more networked devices are “communicatively coupled with” each other and are able to exchange data, possibly via one or more intermediary devices.

### Overview

The growth in program complexity and scale provides growing challenges for today's project managers. Equally, these challenges provide increased challenges for program and portfolio managers who must look at not only the “sum” of individual project performance but also broader portfolio wide performance patterns. Improvements in traditional project management tools must be coupled with advanced analytics, and newer tools geared to detection of negative performance precursors. The following discussion examines one possible tool, sentiment analysis, and its application to detection of performance precursors; positive or negative.

Early prediction of potential trends (e.g., positive trends or negative trends) in program performance is aided by early identification of precursors to sustained negative performance. Among the sources of potential precursors that can be utilized is a wide range of program status documents including electronic correspondence or reports. These reports may be analyzed in many different ways but one approach is to conduct a semantic analysis of the language utilized in the reports. The appearance of semantically negative terms is an early indicator of potential program issues and often is a prelude to formal identification of an issue with defined impacts in structured program reports. The semantic analysis to be conducted is preferentially (but not exclusively) focused on three primary sources of textual data in order to provide higher computational efficiency and increased confidence in the semantic findings: select pairs of correspondence (e.g., emails, text messages, etc.), structured reports, narrative management reports, or other types of communications. Each of these types of electronic documents are described in more detail below.

Select pairs of correspondence, including e-mails or texts, between the project manager and identified senior managers and the project manager and his client counterpart would be included in the described semantic analysis of text. The utilization of e-mail and other electronic text messages that are readily captured provides additional richness to the analysis of the following two categories of reports which are more formal in nature. When applied at sub-tier levels of management processes, organizations and activities, appropriate correspondence pairs would be selected. For example, correspondence between a discipline lead engineer and those engineers and subcontractors supporting the effort he is managing would provide a deeper insight into discipline level performance and could be applied to schedule critical disciplines which evolve and change over a programs lifetime. Similarly, select correspondence between the procurement manager and his team with critical path equipment vendors would provide an early indication of potential supply related issues. Yet another example could include correspondence between a construction manager in a larger program and each of the workface superintendent's. Each of the examples highlighted provides more granular insight and can be utilized to provide additional semantic insight into program performance. Each correspondence pair selected, exclusive of the project manager centric pair, has a different temporal period of interest and would be reflected in the semantic model associated with the particular pairing.

The decision to conduct a narrower semantic analysis of text versus a broader analysis, such as all incoming and outgoing e-mails, is driven by a decision to select high confidence data sets to improve the so called “signal-to-noise” ratio by filtering out the significant noise that may exist more broadly in a project's total correspondence. Even the examples above with respect to other correspondence pairs other than the project manager centric pair are selected narrowly and only for the most temporally significant periods in order to control signal to noise ratios. The semantic analysis conducted on these sub-tier pairs are each considered separately and would further reinforce negative sentiment realized in project manager centric correspondence as well as other semantic analysis conducted on other primary data sets. The importance of context sensitive analysis is discussed later.

One key focus is on a singular critical node, possibly a program or project manager, especially individuals responsible for corresponding performance metrics. In some instances, discrete additional communication pairs may be added, as described previously, but in all instances the intent is to limit such pairs to improve the overall signal-to-noise ratio. Any added pairs would tend to be focused on the most critical issues (e.g., performance metrics) and concerns providing a better signal to noise ratio.

For example, the structure and operation of some programs may make it desirable to include correspondence pairs centered on the deputy project manager or executive sponsor but such broadening should be undertaken in such a way as to minimize the addition of large amounts of noise into the semantical analysis that is to be conducted while also focusing the analysis on a target performance metric (e.g., milestone, rate of construction, etc.).

With respect to structured reports, textual fields addressing issues and concerns in structured and semi-structured periodic project status reports are analyzed as part of the sentiment analysis through a similar semantical analysis of structured report text fields.

These reports typically contain identified text fields focused on overall program management assessment; issues and concerns; risks and forecasts which collectively capture a significant portion of negative sentiment while limiting overall text to be semantically analyzed.

The semantical analysis of these text sources might be the weakest signaler of developing problems given their more formal and structured nature but conversely the strongest signal with respect to “maturing” concerns. Even in these reports, domain-specific negative or positive terminology begins to appear before a “problem” has been formally recognized or declared.

With respect to narrative management reports, periodic, typically weekly or monthly, narrative status reports prepared both for corporate management and importantly for the client are considered in this portion of the analysis. These reports are relatively brief documents and embedded figures and numerical tables could be ignored in favor of the remaining narrative. Together these three data sources can be the primary contextual information to be utilized in a semantic analysis focused on detecting negative “sentiment” as a project precursor.

In looking at broader work on sentiment analysis, there is a growing recognition of the value of broader data sets. This can be seen in the application of sentiment analysis to Twitter feeds for various predictive applications. Concomitantly, there is recognition that broad data sets contain significant amounts of “noise” and even worse uniformed opinions. Within capital programs, such noisy data sets can occlude relevant performance indicators. This is why the inclusion of known, reliable data sources into the analysis has been recognized herein as important to improving overall predictive capabilities.

These other sentiment analyses are of a broader nature than what we encounter in the program management domain and as we have seen previously there is a need to similarly inform this broad analysis with reliable data sources. The semantical analysis described herein focuses on data discretely within the realm of program management as contrasted with a broader project semantical analysis.

The decision to consider only a portion of the text data available within a program context is driven by at least three considerations: the myriad of contexts that are encompassed in a capital program or project setting, achieving high confidence signal-to-noise ratios, or computational efficiency.

The sum of performance across all program performance aspects provides a deeper view into overall program trends or trajectories. When undertaking semantical analysis it is important that negatively or positively correlating terms be considered within the context to be analyzed.

Let us use an example where we look at one term and its usage across the entirety of a project. For simplicity let us assume that the “strength” of negative sentiment is related to the number of occurrences of a single negative term.

In this case let's look at the word “variance”. From examination of program management level reports and communications, the preponderance of usage of this term occurs in a negative context. “Variance” from plan or budget is used by a project manager to describe lagging performance while other semantically positive words are used to describe performance that is “ahead of schedule” or “under budget”.

The term “variance” can be used in a semantically neutral way in other project contexts. Examples include presentations of probabilistic data related risk, test and measurement results, and requests for alternative approvals. Thus a broader text analysis for the term “variance” would result in a large set of “noise” diminishing the utility of a semantical search for the term “variance”

Thus, the list of semantical terms with a negative connotation is highly context sensitive. If we desire to expand the contemplated analysis to include a broader array of program level text it will be important to recognize the applicable contexts more narrowly.

Again, let's use the term “variance” to make the point. If we are to include an analysis of text from a program's engineering department the same contextual challenge remains. For example, “variance” in boring logs may relate to a degree of statistical confidence. Similarly in testing of project bulk materials or even in related risk analyses we may use the term to categorize the homogeneity of the sample or the confidence level ascribed to our assumptions. At later stages of the engineering effort variance might relate to execution performance and assume a relevancy akin to what we find in analysis of project management related texts.

This suggests at least two additional considerations: the need for refined context sensitive semantical lists or terms that reflect more acutely defined domains such at engineering, supply chain, construction, maintenance, inspection, handover, or other capital program domains; and recognition that in some contexts, semantic relevance may be temporal in nature (e.g., across time, program phases, etc.) as was illustrated in the engineering discussion above where the relevance of the term “variation” changed over the course of the engineering activity.

Programs or their associated projects move through various phases, both planned and unplanned. In a well performing, simple project these phases may consist solely of startup, implementation or closeout. The introduction of “disruptions” into program execution patterns whether planned or unplanned changes the project's performance characteristics. Unplanned disruptions in many instances are a result of decisions to implement “recovery” or “workaround” plans that should be preceded by textual data exhibiting negative sentiment.

Additionally, as a program moves through each of the various project phases it faces, the level of textual data to be considered will wax and wane such that even a well performing project will see various semantic instances increase and later decrease over a project's normalized lifetime. This temporal variation is important to consider as one conducts semantical analysis in order to establish appropriate threshold levels for detection of the emergence of negative or even positive sentiment.

The establishment of temporal patterns and threshold levels is similarly context sensitive such that the levels for an Engineering Procurement Construction (EPC) or Engineering Procurement Construction Management (EPCM) project are assumed to be materially different than those for say a Front-End Engineering and Design (FEED) project even within the same program. The establishment of baseline patterns is reliant on a reasonable baseline data set to “tune” the semantic analysis model with. This perhaps represents the greatest challenge faced by project management organizations. As new programs or their associated projects are added to the data set the semantical model is further “tuned”.

In traditional sentiment analysis the various permutations of a term are considered as well as synonyms for the identified term. In highly targeted domains such as the program management domain described in this document terminology is very specific and the use of synonyms carries with it the risk of many “false positives”, which is counter to known traditional sentiment analysis techniques.

Consider the term “variation” again as an example. A listing of synonyms to “variation” in a traditional semantic setting could include words such as: contention, difference, discrepancy, diversity, division, fluctuation, inconsistency, separation, switch, or variety. None of these words, in the selected context, would obviously correlate with negative sentiment. However, in the domain of program management, especially within the context of various projects or project phases, the term “variation” would carry a negative connotation.

Large programs or portfolios of projects present many challenges to senior management. Among them is reliance on “summations” of project performance; limited ability to selectively drill down into individual project performance, often not conducting such “deep dives” until problems emerge; and difficulty in seeing the effects of more systemic impacts until a full blown crisis has emerged.

The application of sentiment analysis as described in herein aids in prioritization of focus, better targeting “deep dives” and at an earlier stage as well as detecting the sudden onset of broader performance issues with respect to performance metrics affecting major portions (multiple projects) in a program or project portfolio. This later ability drives the program manager to more quickly seek systemic causes rather than limit initial efforts to a project by project performance examination.

The following discussion describes use of semantical analysis to determine precursors of potential problems (i.e., leading indicators) through detection of negative, positive or other sentiment in program textual data. The discussed, approach adds one more tool to the project manager's toolbox. But just as one can't build a major project with only one tool, so to must today's project manager use his full toolbox to meet an expanding array of challenges.

The following discussion builds on the subject matter disclosed in co-owned parent patent application titled “Strategic Business Objectives Based Program Management Systems and Methods”, filed Dec. 10, 2012. As described communications (e.g., emails, text messages, reports, etc.) can be analyzed to determine stakeholder opinions or sentiments with respect to SBO topics, including performance measures with respect to one or more aspects of a capital program. Such opinions or sentiments can be considered to represent perception attributes or perceptional information. One type of strategic business objective includes objectives relating to ensuring that performance metrics are not compromised. As the perceptional drift changes, the changes could be reflected in sentiment data, which could be a leading indicator of negative performance.

### Program Management Systems

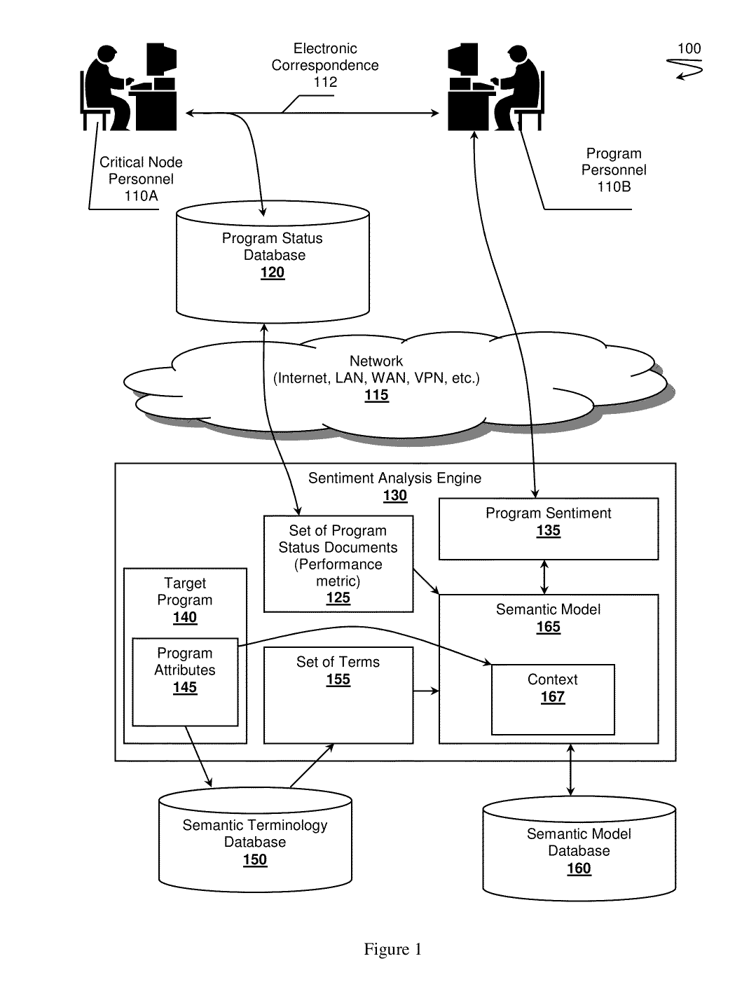

FIG. 1 illustrates program management system 100 that is capable of providing leading insight into possible performance issues associated with a one or more of target program 140 based on sentiment analysis of related program status documents 125. Target program 140 represents a large scale construction program that could include many individual projects, phases, or other program components. Example programs could include building a nuclear power plant, developing a highway system, building an oil recovery system for tar sands, building a diamond mine, or other large capital investment program that could span decades. Target program 140 could include many individual projects, possibly including Engineering Procurement Construction (EPC) projects, Front-End Engineering and Design (FEED) projects, Engineering Procurement Construction Management (EPCM) projects, Engineering Procurement Construction and Maintenance (EPC&M) projects, Engineering, Procurement, Construction Management, and Validation (EPCmV) projects, or other projects. As described below each project could be considered to have its own domain knowledge as represented by semantic terminology database 150.

Project management system 100 comprises semantic terminology database 150 and sentiment analysis engine 130. Semantic terminology database 150 is configured to terms correlated with program attributes and representing perceptional information of a program, target program 140 for example. The terms represent words, phrases, or other unit of communication that are determined to be correlated with program attributes in a manner that allows for retrieving the terms based on a target program. The terms can be compiled, possibly as a concordance, from one or more historical program documents. For each term extracted from the historical documents, the term can then be correlated with the attributes of the program from which the document originated. For example, the term “variance” as discussed previously, could be tagged with metadata (i.e., program attributes) describing the circumstances of its use within the document. Perhaps the documents are structured documents from a design phase of a power plant. In such a circumstance the term “variance” might be correlated with an program attributes “Doc_Type:structured document”, “Program_Phase:Design”, “Program_Type:Power Plant”, or other similar attribute-value pairs. Thus, during analysis of a program, sentiment analysis engine 130 can obtain relevant terms for analysis.

One should appreciate that the terms stored in semantic terminology database 150 could be terms from any language. Further, each term could be represented by a token (e.g., GUID, UUID, etc.) and include localization attributes that represent the term in different languages. For example, a term having a token identifier might have English metadata including the text “bad”. In addition, the same term could also include the text metadata “mal” to represent the same term in Spanish. Although the previous example represents a simple case, the terms could represent a signal word, a multi-word phrase, one word in one language, multiple words in a different language, or even have multiple words for the same term where each word might be considered a synonym in the language. In such a case, the term could also include weighting factors indicate how strongly the term is related to a translation from one language to another.

In some embodiments, semantic terminology database 150 can include a private semantic terminology database. Such an approach is considered advantageous when semantic terminology database 150 stores one or more terms or term sets that are considered proprietary or a trade secret with respect to the entity managing the program or with respect to the client. Further, in view that the target documents to be analyzed can include private communications or structured documents, the private semantic terminology database allows for storing high signal-to-noise terms that are also highly correlated with the culture of the entities, or more specifically, highly correlated with the internal standardized structured documents of the target entity.

Program management system 100 further includes sentiment analysis engine 130 that can offer its services to one or more program personnel 110A through 110B, collectively referred to as personnel 110. In some embodiments, sentiment analysis engine 130 operates as a network-based computing system accessible over network 115 (e.g., the Internet, LAN, WAN, VPN, etc.) as shown. However, it should be appreciated that the roles and responsibilities of sentiment analysis engine 130 could also be deployed in computing devices local to one or more of personnel 110.

In some settings, a program manager, say critical node personnel 110A, engages with sentiment analysis engine 130 to analyze one or more of target program 140. The program manager could engage with sentiment analysis engine 130 via an HTTP interface (not shown) or other similar interface. The program manager can supply sentiment analysis engine 130 with one or of program attributes 145 that describe the nature of target program 140. For example, program attributes 145 could be entered into sentiment analysis engine 130 manually via a web browser or other application interface, or program attribute 145 could be obtain directly from a digital program specification document (e.g., a structured document). Examples of program attributes 145 could include a type of program, a duration of the program or phase, program project identifier, jurisdictional information (e.g., country, region, etc.), target language or languages to be used in the program, equipment types, logistical information, tax information, jurisdictional incentives, personnel identifiers, or other types of program attributes. Additional program attributes can comprise client identifiers, including client associated attributes prom prior programs; prime contract structure attributes including nature and level of any incentives that might modify execution performance and behavior; major risk types identified that may influence overall program methodology; execution office or location including any planned worksharing; client and client personnel information associated with execution style; and designated key project personnel especially the project manager or others where a semantical history may exist in the semantic database.

Based on supplied program attributes 145 of target program 140, sentiment analysis engine 130 obtains set of terms 155 from semantic terminology database 150. In some embodiments, sentiment analysis engine 130 constructs one or more queries and submits the queries to semantic terminology database 150. In response, semantic terminology database 150 provides a results set comprising set of terms 155 that satisfy the query. For example, a query might include program attributes 145 indicating that target program 140 relates to maintenance of a nuclear power plant. In response, set of terms 155 would likely include terms having to do with maintenance, nuclear power plants, or both. Sentiment analysis engine 130 could also obtain set of terms 155 from one or more personnel 110 where personnel 110 could manually enter a desired set of terms 155 via a user interface (e.g., web browser form, CSV file upload, etc.).

Sentiment analysis engine 130 can also obtain semantic model 165 related to target program 140 where semantic model 165 is configured to operate on set of terms 155. Semantic model 165 can also be obtained is a similar fashion as set of terms 155 where obtained. Some embodiments of program management system 100 comprise semantic model database 160 that stores one or more semantic models related to capital programs. Thus, semantic model 165 could be selected from those stored in semantic model database 160. For example, again using program attributes 145, sentiment analysis engine 130 can construct a model query targeting semantic model database 160. Semantic model database 160 returns a results set of one or more of semantic model 165 that might be considered relevant to target project 140. One should appreciate that sentiment analysis engine 130 could automatically select semantic model 165 from a ranked listing of models (e.g., ranked by relevance according to one or more program attributes 145) or could allow program personnel 110 to select semantic model 165.

In some embodiments, sentiment analysis engine 130 uses program attributes 145 to derive context 167 for target program 140. In such circumstances, semantic model 165 could include one or more context templates that define possible scenarios or conditions under which target program 140 operates or under which a term is used within documents 125. For example, if delays are rampant within target program 140, a context template representing a sense of urgency might be relevant. Such an urgency context can be properly defined by assigning urgency values to context 167 as a function of program attributes 145, where the urgency values influence (e.g., down-weight, up-weight, etc.) connotations of terms.

Once instantiated, context 167 can influence the behavior of semantic model 165 as applied to set of terms 155. To continue the previous example, an urgency context might adjust weighting factors of semantic model 165 with respect to terms in set of terms 155. In view that a program urgency on meeting milestones might illicit high emotions, perhaps the semantic weighting factors might be down weighted to provide proper program precursor information. Thus, set of terms 155 can be assigned sentiment values or weightings based on context 167. For example, in the period immediately preceding a major milestone the preponderance of reporting of progress and challenges will be on activities directly related to achievement of this milestone. For example, completion of schedule critical process drawings might dominate project reporting and correspondence, with each and every drawing or specification behind schedule being reflected as a “variance”. The proximate behavior of the process activity at this stage will be well known and while monitoring its improvement semantically is important, we must ensure that other emerging negative sentiments are not drowned out. For example, in an instance where process drawings are struggling to meet schedule we could lose sight of delayed plate steel deliveries important to fabrication of a vessel on the overall project's critical path. The ability to see emerging negative sentiment for other schedule critical or cost critical elements of the program must not be lost in the focus on immediate challenges. This importance cannot be overstated since the normal management tendency will be to address the issue at hand, temporarily losing sight of a potentially larger program management issue and perhaps one more readily and effectively addressed if recognized earlier by the program management team. Other similar instances of issues being lost by noise from known situations could include detailed variance reporting in the final push to complete the construction of a program with delayed training of owner's startup staff lost in the focus and noise of reporting during that period. Sentiment weighting can reflect these considerations, providing “early warnings” to be clearly seen by the management team.

It should be appreciated that semantic model 165 includes rules for assigning connotations or semantic values to each term in set of terms 155. In some embodiments, the term can be assigned connotations representing a possible indirect mapping to sentiment, which could be further refined based on context 167. For example, as discussed above the term “variance” might be assigned a negative connotation according to context 167. The connotation can then be quantified to a semantic value according to semantic model 165. Of particular interest are terms that correlate with a negative connection with respect to program attributes 145. The reason is that negative connotations provide insight or leading indicators with respect to possible issues with program performance. Identifying negative sentiment resulting from the negative connotations early in a program aid in creating a cost effective course correction before major obstacles are encountered or cause significant cost overruns.

Semantic model 165 can include one or more sentiment rules set that govern how sentiment values are derived. In some embodiments, each term in set of terms 155 can be assigned an integer value of 1 for positive sentiment, −1 for negative sentiment, or even 0 for neutral sentiment. Alternatively, each term could be assigned a floating point sentiment value based on a sentiment scale, say −1.0 (negative end of scale) to 1.0 (positive end of scale). Still further, each term could also be assigned an individual weight, again depending on its context, with respect to its contribution to final program sentiment 135. Suitable techniques that can be adapted for use with building semantic model 165 include those described in “Sentiment Analysis and Opinion Mining” by Bing Liu, Morgan & Claypool Publishers, May 2012.

Sentiment analysis engine 130 is further configured to obtain set of program status documents 125, preferably related to one or more performance metrics of target program 140. Set of program status documents 125 represent the evidentiary information from which program sentiment 135 is derived. Set of program status documents 125 could include digital text documents, audio documents, image data, or other types of digital data. In more preferred embodiments, set of program status documents 125 comprises digital text data, possibly converted from other data modalities (e.g., audio-to-text, image-to-text, optical character recognition, etc.). Set of program status documents 125 could include documents from whole target program, from a portion of target program 140, from a project, from a phase, or other subset of documents.

Set of program status documents 125 preferably relates to one or more performance metrics of interest and could be obtained, again through a query, from program status database 120. For example, a program manager could query program status database 120 for all document related to a planned milestone. In response, program status database 120 returns a results set comprising all documents directly or indirectly related to the planned milestone. Example performance metrics could include program milestones, project milestones, rates of construction, logistical efficiency, trends in construction, costs, inspection results, Actual Progress in Process Engineering versus Plan, Forecast Man-hours Process Engineering versus Plan, Actual/Forecast Staffing Plan Process Engineering versus Plan, Actual issue date P&ID's IFD status versus plan, Number of Revisions of P&ID's to final IFD status, Actual issue date process datasheets versus plan, Number of Revisions of process datasheets, Actual issue date plot plan IFD versus plan, Number of Revisions of plot plan to final IFD status, Actual RFP issue date for Piling Contract versus Plan, Number of Revisions of mechanical datasheets, Actual issue date of mechanical RFQ versus plan, Actual date for mechanical bids in versus plan, Actual RFP issue date for Concrete versus Plan, Actual date for mechanical technical and commercial evaluations versus plan, Actual Progress in Piping Engineering versus Plan, Number of Revisions of P&ID's to final IFC status, Actual issue date vendor date versus plan, Actual Bids in Piping Contract versus Plan, Actual Bids E&I contract in versus Plan or other types of metrics.

As discussed above, set of program status documents 125 can include a broad range of documents. Documents considered of special interest include digital performance reports, informal documents such as electronic correspondence 112 among personnel 110, or other types of digital documents. Preferred documents have high signal-to-noise with respect to sentiment or opinion data related to the performance metric. Thus, preferred performance reports can include periodic reports, structured reports, narrative reports, or other reports tightly coupled with target program 140. Although considered to have less signal-to-noise, informal documents (e.g., text messages, emails, photographs, recorded audio, etc.) can also be useful because they typically represent actual opinions of correspondents. In some embodiments, the signal-to-noise of the informal documents can be increased by filtering such documents down to selected pairs of correspondence (e.g., emails) among personnel 110. More specifically, the signal-to-noise of the information documents is considered to be higher when the documents are filtered based on critical node personnel 110A (e.g., program manager, client, project manager, thought leader, etc.).

Sentiment analysis engine 130 analyses terms within set of program status documents 125 according to semantic model 165 to derive program sentiment 135. Each document can be analyzed individually or in aggregate as necessary. The terms in the documents can be cross referenced with the terms in set of terms 155 (accounting for tense, conjugation, word stemming or other term features) to generate an analysis terms set in the set of program status documents 125 that should be analyzed further. The analysis terms set can be further refined by focusing on terms that related to the performance metric of interest, possibly by identify terms in proximity to references to the performance metric, subject data from emails, document title, document metadata, or other factors.

Program sentiment 135 can comprises a broad spectrum of information. One aspect of program sentiment 135 could include a positive sentiment, a negative sentiment, a neutral sentiment, or other sentiment values with respect to the performance metric. One should appreciate that program sentiment 135 could be represented as a single value or multi-valued parameter. A signal value can fall within a range (e.g., −10 to 10, −1.0 to 1.0, 0 to 10, etc.). A multi-valued program sentiment might include a value along with an error estimate or width (e.g., average and width of distribution). Still further, program sentiment 135 can be a leading indicator with respect to issues associated with the performance metric, especially when set of program status documents 125 comprise documents the predate the maturity of the performance metric (e.g., milestones). Once program sentiment 135 has been derived, sentiment analysis engine 130 can configure one or more output devices (e.g., printer, browser-enabled computer, cell phone, etc.) to present program sentiment 135.

### Program Sentiment

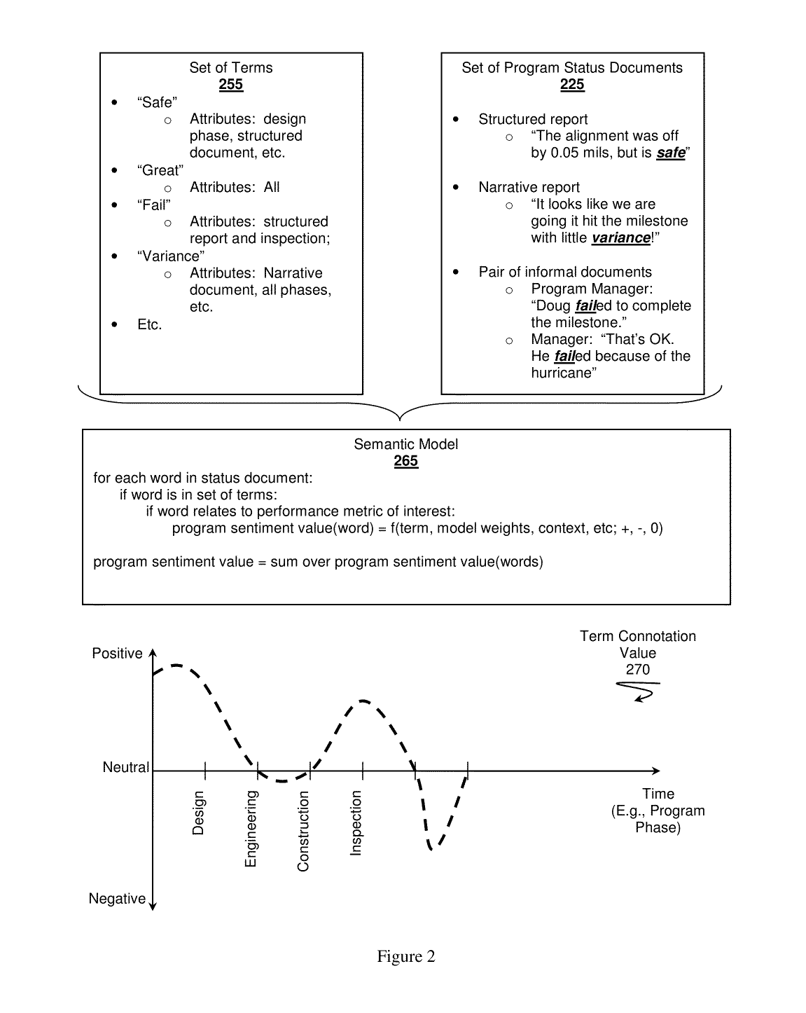

FIG. 2 provides a more detailed example of generation of a program sentiment. The example provided is for illustrative purposes and should not be considered limiting. The sentiment analysis engine 130 obtains set of terms 255, which can include numerous terms, words, or phrases, depending on the nature of the target program. In the example shown, set of terms 255 are illustrated as individual words for clarity. It should be appreciated that set of terms 255 could include individual terms represented by tokens and metadata describing the nature of the term (e.g., word stems, regular expressions, conjugations, relevant program attributes, etc.). Each term can be correlated with one or more program attributes as illustrated.

The sentiment analysis engine further obtains set of program status documents 225 that can include structure reports, narrative reports, informal documents, or other digital documents. In this example, documents 225 have phrases that use terms from set of terms 255, which are targeted for further analysis. The sentiment analysis engine applies semantic model 265 to set of program status documents 225.

Semantic model 265 is illustrated as pseudo code for clarity and as an example. Semantic model 265 can include instructions that cause the processor of the sentiment analysis engine to analyze the terms within the set of program status documents 225. For example and as illustrated, the sentiment analysis engine could scan each word (i.e., a term) in each document. If the word is within set of terms 255 it can be further analyzed, especially if is related to the performance metric of interest. The sentiment value of the word can then be calculated as a function of the term, the term's attributes, weighting factors from model 265, context, or other factors. For this depicted example, the sentiment value of the word takes on a value of +1 for positive sentiment, −1 for negative sentiment, and 0 for neutral sentiment. Finally, the full program sentiment value can be calculated as a sum each word's individual value, possibly normalized to a desired sentiment scale. This example is presented as a simple example. However, one should appreciate that semantic model 265 could employ more than one sentiment analysis technique. For example, each type of program or project could have its own sentiment analysis algorithm.

One should appreciate, as discussed previously, that each term in set of terms 255 could have temporal dependencies as represented by term connotation value 270. Depending on the time stamp, or other temporal value, associated with document in the set of program status documents 225, the connotation of the term could vary dramatically, both in the positive direction or negative direction as illustrated by connotation value 270. Although the example illustrates a continuous function for connotation value 270 of term, one should appreciate that the value could change according to discrete steps. Thus, the terms can be assigned connotations of a function of time according to semantic model 265. Further, the values can be assigned based on a phase of the program (e.g., design phase, engineering phase, construction phase, etc.).

In some embodiments, the program sentiment as a leading indicator can be viewed in hindsight, possibly as a post mortem review of the target program. Such an approach is considered advantageous because the actual program performance metrics can be compared to performance metrics that we considered at issue as indicated by the program sentiment leading indicator. If the actual performance metrics do not deviate as expected based on the program sentiment, then semantic model 265 can be adjusted accordingly to tune semantic model 265 based on the actual performances measured for the target program. For example, if the program sentiment with respect the performance metric indicated a potential problem on the horizon, but none materialized, then the weighting factors within model 265 for terms in set of terms 255 can be down weighted or otherwise adjusted.

### Generating Program Sentiment

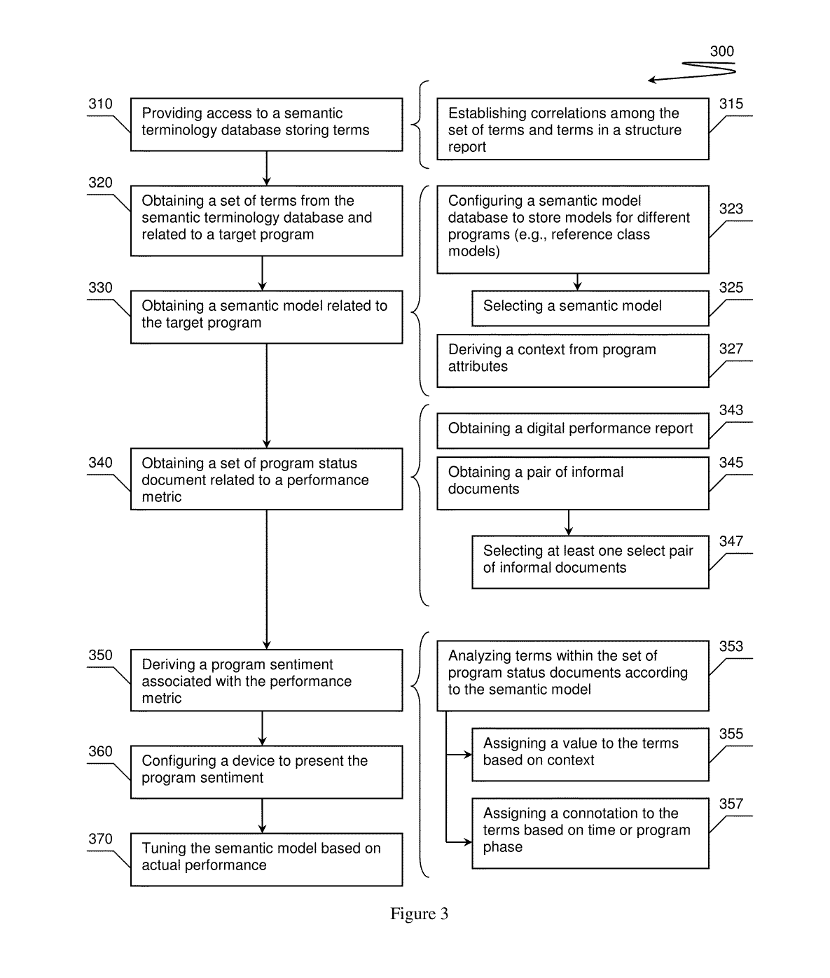

FIG. 3 presents a possible embodiment of the inventive subject matter from the perspective of method 300. Method 300 represents a method of generating a program sentiment via a sentiment analysis engine.

Starting at step 310, method 300 includes providing access to a semantic terminology database storing terms correlated with program attributes and representing perceptional information of a program. In some embodiments, the semantic terminology database, possibly a private semantic terminology database, can include one or more types of database infrastructure (e.g., SQL, PostgreSQL, Access, etc.) having a schema configured to store terms and their associated metadata. The semantic terminology database can be stored within a memory of the computing device, possibly within the device operating as the sentiment analysis engine, a separate computing device operating as a network-accessible database, or other instantiation. In some embodiments the semantic terminology database stores terms correlated with enterprise level portfolio performance attributes and representing perceptional information of cross functional performance of all programs in the portfolio.

As discussed previously, terms stored in the semantic terminology database can be correlated with program attributes in the database schema so they can be retrieved via one or more queries constructed based on program attributes. Some embodiments, as suggested by step 315, include establishing correlation among the set of terms in the database and terms from a structured report. In view that structured reports are highly formalized, use of terms from such reports are considered to generate high signal-to-noise sentiment data.

Step 320 can include the sentiment analysis engine obtaining a set of terms from the semantic terminology database based on attributes of a target program or attributes of an enterprise and the portfolio of programs. Possibly in response to a program manager or other user supplying information about the target program, the sentiment analysis engine constructs a query as a function of the program attributes of the target program. The query could include one or more attribute-value pairs representing aspects of the target program. The semantic engine can submit the query to the semantic terminology database via an application program interface (API), web service, HTTP Get, or other protocol. In response, the semantic terminology database returns a results set comprising term objects having data that satisfies the query. In other embodiments, the program manager or other user can manually provide terms considered of interest, possibly via a file or form interface on a GUI.

Step 330 can include the sentiment analysis engine obtaining a semantic model related to the target program where the semantic model is configured to operate as a function of the set of terms. There are numerous ways in which the semantic model can be obtained. One should appreciate that the semantic model could be related to the enterprise and the portfolio of programs as well. In some embodiments, a user can select one or more semantic model objects via a Graphic User Interfaces, where each semantic model object includes executable instructions that assign values or connotations to the terms. In other embodiments, the semantic model can be obtained from a semantic model database. For example, step 323 could include configuring a semantic model database to store a plurality of semantic models related to different types of programs. Each of the semantic models could be indexed by program attributes so that the sentiment analysis engine can retrieve models of interest including pre-constructed reference class models or the creation of a new reference class model. Further, step 325 could include selecting one or more of the semantic models from the plurality of semantic models, possibly via a query submitted to the semantic model database or even via user selection of a model from the results set generated by the query. Such semantic models and any associated reference classes could differ for purposes of assessing cost or schedule sentiment which vary or manifest themselves in different time horizons.

Step 327 could include deriving one or more contexts from the program attributes of the target program according to the semantic model. The context aid in differentiating usage of terms based on possible circumstances surrounding when the program status documents were created. For example, a context might include personnel issues (e.g., problematic personnel, high performers, etc.). In which case, the set of terms might be interpreted differently based on the context and according to the selected semantic model. The terms used by problematic personnel might be down weighted to remove possible overly negative, unhelpful terms. Thus, the contexts can influence how terms are interpreted with respect to assessing cost or schedule sentiment.

Step 340 can include the sentiment analysis engine obtaining a set of program status documents, possibly enterprise level performance status documents of a portfolio, related to a performance metric of the target program. Further, the performance metrics can relate to programs across the portfolio of programs. The documents could be obtained automatically from a document database as discussed previously. In other embodiments, a user could upload one or more digital documents to the sentiment analysis engine possibly via a protocol capable of supporting file transfer (e.g., FTP, TFTP, HTTP, etc.). Example documents include digital performance reports, periodic reports, structured reports, narrative reports, or other types of reports. The program status documents preferably reference or are in regards to a performance metric of interest (e.g., milestones, performance trends, progress data, etc.).

Of particular interest, at step 345, method 300 can include the sentiment analysis engine obtaining at least one pair of informal documents. Informal documents preferably include electronic correspondence among personnel associated with the target program (e.g., emails, text messages, voice messages, video calls or messages (e.g., Skype, Hangouts, etc.), digital pictures, etc.). Pairs of informal documents aid in increasing signal-to-noise of performance issue precursor information because a pair of documents represent an acknowledged exchange of information. To further increase the signal-to-noise, step 347 includes the sentiment analysis engine selecting at least one select pair of electronic correspondence as the one pair of information documents, preferably where the select pair of electronic correspondence is associated with critical node personnel of the target program (e.g., program manager, project manager, client, etc.), which may change over the course of the program when sub-tier pairs (pairs below the program manager and executive level) are considered. Selecting a pair of correspondence that are associated with a critical node ensures the opinion information related to the performance metric is from a reliable source.

Step 350 includes the sentiment analysis engine deriving a program sentiment, possibly an enterprise level sentiment, associated with the performance metric. In more preferred embodiments, at step 353 the sentiment analysis engine analyzes terms within the set of program status document according to the semantic model. For example, the semantic model instructs the sentiment analysis engine how to assign values to the terms, possibly based on a context of use (e.g., urgency, program phase, type of communication, etc.). Thus, step 355 includes the sentiment analysis engine assigning a value to the terms based on the context. Each term can be assigned a numerical value (e.g., +1, −1, 0, etc.) as discussed previously to represent its contribution to the total program sentiment associated with the performance metric. Further, step 357 can include assigning connotations to the set of terms as a function of time and according to the semantic module. As discussed previously the connotation of a term can vary with respect to time; program phases for example. Thus, a term can be evaluated or assigned a sentiment value based on the connotation for each individual time or phase. The resulting program sentiment with respect to the performance metric can include a positive sentiment value, a negative sentiment value, a neutral value, or other value within a spectrum of sentiment. Such program sentiments having negative values are considered a leading indicator to possible problems or issues with performance metric that have yet to mature.

Step 360 includes the sentiment analysis engine configuring a device to present the program sentiment. In some embodiments, the program sentiment can be presented as a numeric values juxtaposed with the corresponding performance metric on a display screen or printed report. In embodiments where the program is one of a portfolio of programs, the device can be configured to present an enterprise level sentiment associated with overall portfolio performance sentiment, cross program sentiment, or cross-functional sentiment. For example, a program manager can conduct an analysis of numerous aspects of the program with corresponding performance metrics. Perhaps the performance metrics are presented in a temporal fashion, showing near term metrics as well as future metrics. Each of the performance metrics can also be presented with corresponding program sentiments, possibly along with a confidence score indicating how strongly the program sentiments indicate problems. Near term metrics would likely have higher confidence scores (e.g., high percentage or probability of being accurate, lower error bars, etc.) on their program sentiments while metrics that are further in the future might have lower confidence scores (e.g., lower percentage or probability of being accurate, larger error bars, etc). Display of sentiment information would be dynamic in nature, changing as new areas of negative sentiment take of increased importance.

In view that a large scale entity could manage hundreds or thousands of programs, step 370 can include tuning the semantic model based on actual performance metrics measured from the target program. Once performance metrics are measured or properly matured, the history of the program sentiments can be compared to determine if they were indeed a leading indicator of actual performance issues. If they were not, either positive or negative, then the rules of the semantic models can be adjusted to retro fit the program sentiments so they better align with the actual data. Such an approach provides for feeding back actual measurement in the semantic model to ensure future programs have solid leading indicators of performance issues based on actual evidence. The semantic model can be adjusted by changing term weighting factors, adjusting connotations, modifying contexts, modifying rules for relevancy of terms, or other factors. Similar semantic history and model refinement could be applied to semantic models that may be program manager, client, project type or execution office specific for example.

It should also be recognized that portfolios of programs can be semantically analyzed in a similar fashion to provide early identification of common drivers (market demand for the product driving all programs of a given type to seek to accelerate, common constraints (structural steel or welder shortages), cross functional performance issues (process design late on all projects in the portfolio) and enterprise level financial trends (greater than expected margin erosion, reduced achievement of potential incentives).

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A capital program management system comprising:
a semantic terminology database storing terms correlated with program attributes and representing perceptional information of a program; and
a sentiment analysis engine coupled with the semantic terminology database and configured to:
obtain a set of terms from the semantic terminology database based on attributes of a target program;
obtain a semantic model related to the target program, the semantic model configured to operate as a function of the set of terms;
obtain a set of program status documents related to a performance metric of the target program;
derive a program sentiment associated with the performance metric by analyzing terms within the set of program status documents according to the semantic model; and
configure a device to present the program sentiment.

2. The system of claim 1, wherein the semantic terminology database comprises a private semantic terminology database.

3. The system of claim 1, wherein the set of program status documents comprises a digital performance report.

4. The system of claim 3, wherein the performance report comprises a periodic report.

5. The system of claim 4, wherein the performance report comprises a structured report.

6. The system of claim 5, wherein the set of terms are correlated with the structured report.

7. The system of claim 4, wherein the performance report comprises a narrative report.

8. The system of claim 1, wherein the set of program status documents comprises at least one pair of informal documents.

9. The system of claim 8, wherein the at least one pair of information document comprises at least one select pair of electronic correspondence.

10. The system of claim 8, wherein the at least one pair of information documents are associated with critical node personnel of the program.

11. The system of claim 1, wherein the program sentiment comprises at least one of the following: a positive sentiment, a negative sentiment, and a neutral sentiment with respect to the performance metric.

12. The system of claim 1, wherein the program sentiment comprises a leading indicator with respect to issues associated with the performance metric.

13. The system of claim 1, wherein the set of terms correlate with a negative connotation with respect to the program attributes.

14. The system of claim 1, wherein the semantic model comprises a context derived from the program attributes of the target program.

15. The system of claim 14, wherein the set of terms are each assigned a value based on the context.

16. The system of claim 1, wherein the set of terms are assigned connotations as a function of time according to the semantic model.

17. The system of claim 1, wherein the set of terms are assigned connotations based on program phase.

18. The system of claim 1, wherein in the sentiment analysis engine is further configured to tune the semantic model based on actual performances measured from the target program.

19. The system of claim 1, further comprising a semantic model database storing a plurality of semantic models related to different types of programs.

20. The system of claim 19, wherein the semantic model is selected from the plurality of semantic models.

21. A method of generating a program sentiment via a sentiment analysis engine, the method comprising
providing access to a semantic terminology database storing terms correlated with program attributes and representing perceptional information of a program;
obtaining, via the sentiment analysis engine, a set of terms from the semantic terminology database based on attributes of a target program;
obtaining, via the sentiment analysis engine, a semantic model related to the target program, the semantic model configured to operate as a function of the set of terms;
obtaining, via the sentiment analysis engine, a set of program status documents related to a performance metric of the program;
deriving, via the sentiment analysis engine, a program sentiment associated with the performance metric by analyzing terms within the set of program status documents according to the semantic model; and
configuring a device to present the program sentiment.

22. The method of claim 21, wherein the semantic terminology database comprises a private semantic terminology database.

23. The method of claim 21, wherein the step of obtaining the set of program status documents includes obtaining a digital performance report.

24. The method of claim 23, wherein the performance report comprises a periodic report.

25. The method of claim 24, wherein the performance report comprises a structured report.

26. The method of claim 25, further comprising establishing correlations among the set of terms and terms from the structured report.

27. The method of claim 24, wherein the performance report comprises a narrative report.

28. The method of claim 21, wherein the step of obtaining the set of program status documents includes obtaining at least one pair of informal documents.

29. The method of claim 28, further comprising selecting at least one select pair of electronic correspondence as the one pair of informal documents.

30. The method of claim 28, wherein the at least one pair of information documents are associated with critical node personnel of the program.

31. The method of claim 21, wherein the program sentiment comprises at least one of the following: a positive sentiment, a negative sentiment, and a neutral sentiment with respect to the performance metric.

32. The method of claim 21, wherein the program sentiment comprises a leading indicator with respect to issues associated with the performance metric.

33. The method of claim 21, wherein the set of terms correlate with a negative connotation with respect to the program attributes.

34. The method of claim 21, further comprising deriving a context from the attributes of the target program according to the semantic model.

35. The method of claim 34, further comprising assigning a value to the set of terms based on the context.

36. The method of claim 21, further comprising assigning connotations to the set of terms as a function of time and according to the semantic model.

37. The method of claim 21, further comprising assigning connotations to the set of terms as a function of program phase.

38. The method of claim 21, further comprising tuning the semantic model based on actual performances measured from the target program.

39. The method of claim 21, further comprising configuring a semantic model database to store a plurality of semantic models related to different types of programs.

40. The method of claim 39, further comprising selecting the semantic model from the plurality of semantic models.

41. A method of generating an enterprise wide sentiment for a portfolio of programs via a sentiment analysis engine, the method comprising
providing access to a semantic terminology database storing terms correlated with enterprise level portfolio performance attributes and representing perceptional information of cross functional performance of all programs in the portfolio;
obtaining, via the sentiment analysis engine, a set of terms from the semantic terminology database based on attributes of the enterprise and the portfolio of programs;
obtaining, via the sentiment analysis engine, a semantic model related to the enterprise and the portfolio of programs, the semantic model configured to operate as a function of the set of terms;
obtaining, via the sentiment analysis engine, a set of enterprise level performance status documents related to a performance metric in programs comprising the portfolio;
deriving, via the sentiment analysis engine, an enterprise level sentiment associated with the enterprise performance metrics by analyzing terms within the set of program status documents according to the semantic model; and
configuring a device to present the enterprise level sentiment associated with portfolio performance, cross-program, and cross functional sentiment.
